(19) United States
(12) Patent Application Publication
(10) Pub. No.: US 2022/0114501 A1
(43) Pub. Date: Apr. 14, 2022

(54) METHOD AND SYSTEM FOR TRANSMITTING A PROMPT REQUEST

(71) Applicant: VULOG, Nice (FR)

(72) Inventor: François COLON, Marseille (FR)

(73) Assignee: VULOG, Nice (FR)

(21) Appl. No.: 17/418,968

(22) PCT Filed: Dec. 24, 2019
(86) PCT No.: PCT/FR2019/053295

§ 371 Date: Jun. 28, 2021

(30) Foreign Application Priority Data
Dec. 28, 2018 (FR) 1874382

(51) Int. Cl. G06Q 10/02; G06Q 50/30; G01C 21/34

(52) U.S. Cl. CPC G06Q 10/02; G01C 21/3492; G06Q 50/30

(57) ABSTRACT

A method for transmitting a prompt request, including: calculation by a server of a first number of requests to reserve vehicles in a fleet of shared vehicles, in a predetermined geographical area, the calculation of the first number taking into account: the number of reservation requests actually received by the server at a given moment, and/or a number of estimated reservation requests, determination by the server of the geographical positions of the fleet vehicles, calculation of a second number of fleet vehicles that are available in the geographical area, comparison by the server of the first and the second number, if the second number is lower than the first number, identification by the server of the fleet vehicles—which are not available and are in operation; and the geographical position of which is in the geographical area or at a predetermined distance from the geographical area.

### TECHNICAL FIELD

The invention concerns a method and a system for transmitting a prompt request.

The field of the invention concerns in particular the methods for releasing a shared vehicle in a determined geographical area and more generally the methods for managing a fleet of shared vehicles.

### STATE OF THE ART

A car-sharing service or self-service vehicles is a system in which a company, a public agency, a cooperative, an association, or a group of individuals, makes available to “customers” or members of the service one or more vehicle(s) (hereinafter “fleet of vehicles”). Rather than having a personal vehicle, the user of the service has a vehicle that he pays only for the duration of his need. In other words, when a user uses a shared vehicle, he is billed for a certain amount. The billed amount generally depending on the number of traveled kilometers and/or the time of use of the vehicle and/or the model or type of vehicle. The rest of the time, the vehicle is intended to be used by other members.

It may happen that at a given period (for example every Friday between 6 p.m. and 8 p.m.) and in a particular geographical area (for example at the exit of a train station), the demand for reservation of the vehicles is very high. To date, no effective solution encourages a user to release his vehicle in this geographical area and during this given period.

The document US 2015/0206206 (PUENTE) describes a method and a system for exchanging vehicles between drivers. A server can store the rental wish requests of a first user and notify another registered user that the first user wishes to exchange in or rent his vehicle. The system proposes assisting the exchange by defining a place and time for exchange. The exchange request can include tariff or duration data. A drawback of this system is that each user must set a meeting point which is accepted by common agreement. The described system does not propose service to people wishing to be able to simply have a vehicle according to where they are, without necessarily having to negotiate with other users.

An objective of the invention is to overcome the aforementioned drawbacks. Another object of the invention is to propose a method allowing targeting the transmission of a prompt request in order to effectively encourage users to release their vehicle to meet the needs of other users in the community. Another object of the invention is to propose a solution for quickly making vehicles available to users depending on their location, without having to directly negotiate with other users.

### Presentation of the Invention

The solution proposed by the invention is a method for transmitting a prompt request including the following steps:
a) calculation, by a computer server, of a first number of requests to reserve vehicles in a fleet of shared vehicles, in a predetermined geographical area, the calculation of said first number is carried out taking into account:
   the number of actual reservation requests received by the computer server at a given moment,
   and/or a number of estimated reservation requests, which number is based on a history of the actual reservation requests received by the computer server, during a previous period of time,
b) determination by the computer server, of the geographical positions of the fleet vehicles and calculation of a second number of fleet vehicles which are available in the geographical area,
c) comparison, by the computer server, of the first number and the second number,
d) if the second number is lower than the first number, then identification, by the computer server, of the fleet vehicles:—which are unavailable and in operation;—and whose geographical position is located in the geographical area or at a predetermined distance from said geographical area,
e) generation, by the computer server, of a prompt request including the location of the geographical area,
f) automatic transmission of this prompt request, from the computer server via a wireless connection, to the identified fleet vehicles or to at least one equipment of the users of said identified vehicles.

Thanks to this method, the transmission of the prompt requests is targeted such that a large number of users can be encouraged to release their shared vehicle in a geographical area where the demand for use is high. The computer server only targets the users who are potentially the most likely to free their vehicle in the concerned area, which allows reducing the number of requests transmitted by the server (which is a gain in terms of processing time and mobilized computing resources) while significantly increasing the efficiency of the service. In addition, these targeted users automatically receive the prompt requests from the computer server, and no longer from other users in request, unlike to what US 2015/0206206 advocates, which allows avoiding any negotiation between users. Furthermore, the computer server automatically and autonomously evaluates the rate of usage demands and only generates the prompt requests if the demand is greater than the offer. The gain in terms of processing time and mobilized computing resources is still appreciable from this point of view. The server thus autonomously manages the offer and the demand, thereby optimizing the relevance of the service.

Other advantageous features of the invention are listed below. Each of these features can be considered alone or in combination with the remarkable features defined above, and be the subject, where appropriate, of one or more divisional patent applications:
According to one embodiment, as soon as the number of actual reservation requests received by the computer server at a given moment, exceeds the number of estimated reservation requests, then said server considers only said number of actual reservation requests for the calculation of the first number.
According to one embodiment, step e) comprises a sub-step consisting in associating an electronic billing discount coupon with the prompt request, which coupon has a limited validity over time.
According to one embodiment, furthermore the following steps:
   g) generation and transmission of an availability indicator to the computer server, from a fleet vehicle which is made available or from a mobile equipment of the user of said vehicle, via a wireless connection,
   h) determination, by the computer server, of the geographical position of said vehicle and of an amount to be billed following the use of said vehicle,
   i) application, by the computer server, of the billing discount to said amount to be billed under the following conditions:—the geographical position of the vehicle corresponds to the location of the geographical area,—and the prompt request generated in step e) has been transmitted to the vehicle or to the mobile equipment of the user of said vehicle, prior to the generation of the availability indicator of step g),—and the discount coupon is valid.
According to one embodiment, step f) comprises a sub-step consisting in storing, in a memory area of the server, identifiers of the fleet vehicles to which the prompt request generated in step e) has been transmitted.
According to one embodiment: step g) comprises a sub-step consisting in associating an identifier of the vehicle with the availability indicator;—in step i), the computer server compares the identifier associated with the availability indicator with the identifiers stored in the memory area thereof, to determine whether the prompt request generated in step e) has been transmitted to the vehicle or to the mobile equipment of the user of said vehicle, prior to the generation of the availability indicator of step g).
According to one embodiment, the method further comprises the following steps:
   g) generation and transmission of an availability indicator to the computer server, from a fleet vehicle which is made available or from a mobile equipment of the user of said vehicle, via a wireless connection, the discount coupon being associated with said availability indicator if said coupon is valid,
   h) determination, by the computer server, of the geographical position of said vehicle and of an amount to be billed following the use of said vehicle,
   i) application, by the computer server, of the billing discount to said amount to be billed, if the geographical position of said vehicle corresponds to the location of the geographical area.
According to an alternative embodiment, the method further comprises the following steps:
   g) generation and transmission of an availability indicator to the computer server, from a fleet vehicle which is made available or from a mobile equipment of the user of said vehicle, via a wireless connection, the discount coupon being associated with said availability indicator,
h) determination, by the computer server, of the geographical position of said vehicle and of an amount to be billed following the use of said vehicle,
i) application, by the computer server, of the billing discount to said amount to be billed, if the geographical position of said vehicle corresponds to the location of the geographical area, and if the discount coupon is valid.
According to one embodiment, step e) comprises a sub-step consisting in including, in the prompt request, one or more route(s) for conveying to the location of the geographical area.

Another aspect of the invention concerns a system for transmitting a prompt request, said system including a computer server adapted to communicate, via wireless connections, with the fleet vehicles, which server includes at least one processing unit, and at least one memory comprising one or more computer application(s) whose instructions, when executed by said processing unit, allow said server:
a) to calculate a first number of requests to reserve vehicles in a fleet of shared vehicles, in a predetermined geographical area, the calculation of said first number is carried out taking into account:
   the number of actual reservation requests received by the computer server at a given moment,
   and/or a number of estimated reservation requests, which number is based on a history of the actual reservation requests received by the computer server, during a previous period of time,
b) to determine the geographical positions of the fleet vehicles and calculate a second number of available fleet vehicles in the geographical area,
c) to compare the first number and the second number,
d) if the second number is lower than the first number, then to identify fleet vehicles:—which are unavailable and in operation;—and whose geographical position is located in the geographical area or at a predetermined distance from said geographical area,
e) to generate a prompt request including the location of the geographical area,
f) to automatically transmit this prompt request, via a wireless connection, to the identified fleet vehicles or to at least one mobile equipment of the users of said identified vehicles.

### DESCRIPTION OF THE FIGURES

Other advantages and features of the invention will appear better on reading the description of a following preferred embodiment which follows, with reference to the appended drawings, made by way of indicative and non-limiting examples and in which:

FIG. 1 illustrates an exemplary embodiment of a system for implementing the invention,

FIG. 2 is an exemplary embodiment of the steps of a method in accordance with the invention.

### DESCRIPTION OF THE EMBODIMENTS

The method and the system which are the subjects of the invention generate manipulations of physical elements, in particular (electrical or magnetic) signals and digital data, capable of being stored, transferred, combined, compared, . . . , and allowing achieving a desired result.

The invention implements one or more computer application(s) executed by computer equipment or servers. For the sake of clarity, it should be understood within the meaning of the invention that “an equipment or server does something” means “the computer application executed by a processing unit of the equipment or the server does something”. Just as “the computer application does something” means “the computer application executed by the processing unit of the equipment or the server does something”.

Still for the sake of clarity, the present invention is likely to refer to one or more “logical computer processes”. Sad processes correspond to the actions or results obtained by executing instructions from different computer applications. Also, it should further be understood within the meaning of the invention that “a logical computer process is adapted to do something” means “the instructions of a computer application executed by a processing unit do something”.

Again for the sake of clarity, the following clarifications are made to some terms used in the description and the claims:
“Computer resource” can be understood without limitation as: component, hardware, software, file, connection to a computer network, amount of RAM memory, hard disk space, bandwidth, processor speed, number of CPUs, etc.
“Computer server” can be understood without limitation as: computer device (hardware or software) including computer resources to carry out the functions of a server and which offers services, computer, plurality of computers, virtual server on the Internet, virtual server on Cloud, virtual server on a platform, virtual server on a local infrastructure, server networks, cluster, node, server farm, node farm, etc.
“Service” can be understood without limitation as the set of functionalities which are proposed and provided by a server and by at least one equipment connected to said server SERV via a network. The service can comprise, for example, the following functionalities: the reservation of a shared vehicle from a list of available vehicles, the localization of a shared vehicle, for example on a digital map displayed on a user equipment, making available a shared vehicle after a period of use, the remote unlocking of a shared vehicle after a validated reservation, the remote locking of a shared vehicle after the end of use of a vehicle, etc.
“Request” designates an execution order which can follow a communication protocol and comprising input parameters (question, information, . . . ) and possibly return parameters (response, information, . . . ), which can be presented in a format linked to the used protocol.
“Processing unit” can be understood without limitation as: processor, microprocessors, CPU (for Central Processing Unit).
“Computer hardware” represents one or more spare parts of computer equipment and can be understood without limitation as hardware.
“Computer application” can be understood as: software, computer program, software program, etc.
“Network” can be understood without limitation as: computer bus, personal network (PAN), local network (LAN, WLAN, . . . ), wide area network (WAN), internet network, intranet network, extranet network. The computer network is a set of computer equipment connected to each to exchange, in a secure or unsecured manner, information and/or data according to a communication protocol (ISDN, Ethernet, ATM, IP, CLNP, TCP, HTTP, . . . ).
“Database” can be understood without limitation as a structured and organized set of data stored on media accessible by computer equipment and which can be queried, read and updated. Data can be inserted therein, recovered, changed and/or destroyed. The management and access to the database can be provided by a set of computer applications which constitute a database management system (SGBD).
“Shared vehicle” or “car sharing” is a vehicle made available to “customers” or members. When a user uses a shared vehicle, he is billed for a certain amount, generally depending on the number of traveled kilometers and/or the time of use of the vehicle and/or the model or type of vehicle. The vehicle can be a car, an autonomous car, a motorcycle, a bicycle, a scooter, a boat, etc.
“Fleet” or “pool” can be understood as a plurality of shared vehicles belonging to a company, a public agency, a cooperative, an association, a group of individuals.
As used herein, unless otherwise indicated, the use of the ordinal adjectives “first”, “second”, “third”, etc., to describe an object simply indicates that different occurrences of similar objects are mentioned and does not imply that the objects thus described must be in a given sequence, whether in time, in space, in a classification or in any other manner

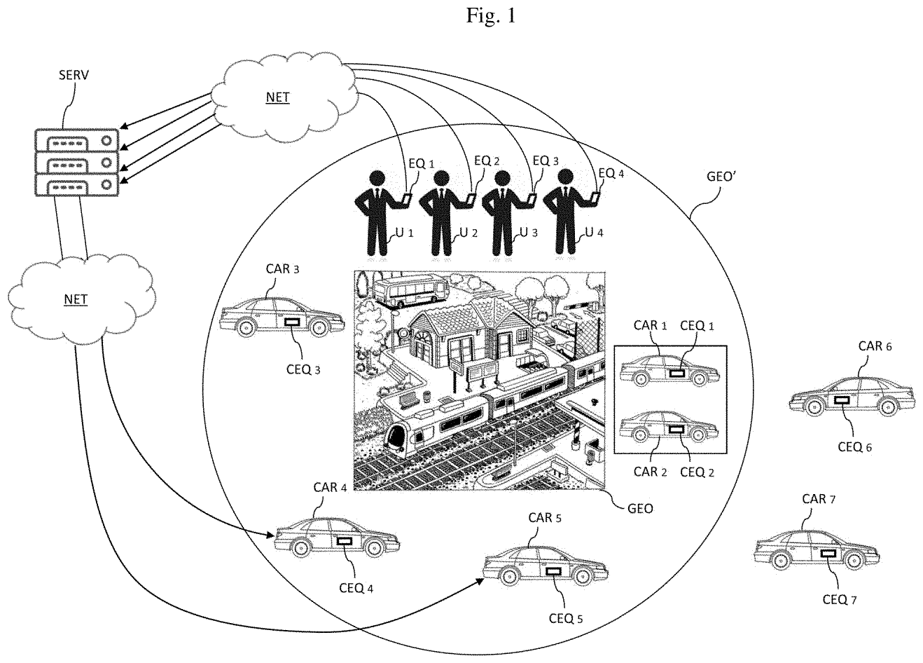

In FIG. 1, the system for implementing the method of the invention comprises a computer server SERV, a fleet of shared vehicles CAR1-CAR7, and users U1-U4. The geographical area GEO used to exemplify the invention is herein a train station. More generally, the geographical area GEO can consist of a specific geographical position (for example defined by an address or GPS coordinates) or a larger geographical region including several geographical points, for example the district of a city (predefined in a database and corresponding to a region defined by a postal code or by a region delimited by streets and defining known districts) or an area defining a circle having a specific geographical position as center (e.g. the center of the station) and a predefined radius or diameter (ex: radius of 200 m).

The users U1-U4 each have at least one mobile equipment EQ1-EQ4 which is electronic equipment including a communication interface, for example GSM, 3G, 4G or Wifi, to establish a wireless communication connection with the server SERV through a network NET. The latter is for example an Internet network, based on an infrastructure allowing wireless communications from equipment EQ1-EQ4 to be routed. The equipment EQ1-EQ4 are preferably smartphones, digital tablets, laptops, etc. They comprise computer resources, for example an executable code of a downloadable computer application, allowing carrying out functions of the method of the invention. According to one embodiment, each user Ui is registered with a right management server which may or may not be the remote server SERV. The users Ui access a service corresponding to the access to the vehicles CAR1-CAR7. The registration of a user can be carried out with a web service of a remote server associated with the service. The registration includes for example the registration of a user identifier Ui and a network address of the user equipment EQi, it can be a port, an IP address, a MAC address or any other address or combinations of elements constituting addresses allowing identifying a user equipment EQi. According to one embodiment, the users Ui are pre-enrolled from a software and are known from the fact that an identifier is registered in a remote database. According to one embodiment, a database associates a vehicle CARi with a user Uj when the latter uses the vehicle CARi. According to one embodiment, the server SERV includes a function allowing carrying out the associations.

Each vehicle CAR1-CAR7 is associated with a unique identification number. Each vehicle CAR1-CAR7 advantageously has at least one on-board equipment CEQ1-CEQ7 including a communication interface, for example GSM, 3G, 4G or Wifi, to establish a wireless communication connection with the server SERV through a network NET. The equipment CEQ1-CEQ7 are preferably on-board computers comprising the computer resources allowing carrying out functions of the method of the invention. At a given moment, the vehicles CAR1-CAR7 can be:
with a status called “Available”: the vehicle is parked and not reserved,
with a status called “Unavailable”: either the vehicle is parked but already reserved by a user (“Unavailable-Reserved” status), or the vehicle is in operation (“Unavailable-in operation” status). In the latter case, it will be considered that a user (not represented in FIG. 1) is installed in the vehicle and has mobile electronic equipment similar to the equipment EQ1-EQ4.

The server SERV regularly updates, preferably in real time, a database of the fleet vehicles. This database brings together in particular: the identifier of each vehicle CARi, the status thereof (“Available” or “Unavailable-Reserved” or “Unavailable-in operation”), and the geographical position thereof. Other information and/or data may be brought together in the database, where appropriate. The database can be stored in a memory area of the server SERV or be remote from said server and connected to the latter.

Information on the status of a vehicle CARi is transmitted to the server SERV in real time or at predefined time intervals (for example every 5 minutes). This information can be transmitted to the server SERV:
by the on-board equipment CEQi of the vehicle CARi following a detection of an event. This event is for example generated by an action of the user on a specific control arranged on the dashboard of the vehicle CARi. This control can be actuated when the user has parked his vehicle and released the vehicle. The status then changes from “Unavailable-in operation” to “Available”,
by the equipment EQj of the user Uj of the vehicle CARi, following an action by said user on his equipment. The user can for example actuate a dedicated key displayed on a touch screen of his equipment, after having parked and released his vehicle. The status then changes from “Unavailable-in operation” to “Available”.

When the server SERV receives a reservation request from a user and can grant this request (that is to say that a vehicle is available for reservation), said server changes the status of a vehicle from “Available” to “Unavailable-Reserved”. This reservation request can, for example, be generated via equipment EQj or via a computer application to which the user Uj is subscribed.

The geographical position can be obtained by satellite (GPS or Galileo system) or by a triangulation system (for example, a system using the cells of a 4G network) or by a combination of the two localization systems. The equipment CEQi of a vehicle CARi advantageously includes a component, for example a GPS component, allowing obtaining a geo-localization information which can be recovered by the server SERV. The server SERV can automatically recover this information by querying in real time or at regular time intervals (for example every 5 minutes), the equipment CEQi of the vehicles. The equipment of the vehicles can also automatically transmit this information to the server SERV (without responding to a query request), in real time or at regular time intervals (for example every 5 minutes). Alternatively, the geographical position of a vehicle CARi can correspond to a position defined from an input interface of equipment EQj of a user Uj using the vehicle CARi. For example, the user Uj can evaluate a position from an interactive map displayed on a graphical interface of his equipment EQj. This position is then transmitted to the server SERV.

In the example of the FIG. 1, the vehicles CAR1 and CAR2 are parked near the station GEO (for example in a dedicated parking) and are free (“Available” status). The vehicles CAR3-CAR6 are in operation (“Unavailable-in operation” status) and the vehicle CAR7 is stationed but already reserved by a user (“Unavailable-Reserved” status). The users U1-U4 are in the train station GEO, or in the vicinity thereof, and wish to make a vehicle reservation in this area. To do this, they transmit to the server SERV a reservation request, which is for example generated from their equipment EQ1-EQ4 or via a computer application to which the users are subscribed.

The users U1-U4 indicate the geographical area where they wish to recover their vehicle. The localization of this geographical area can be by default the geographical position of the users U1-U4 at the time when they transmit their reservation request. This position can be obtained by satellite (GPS or Galileo system) or by a triangulation system (for example, a system using the cells of a 4G network) or by a combination of the two localization systems. Each equipment EQ1-EQ4 advantageously includes a component, for example a GPS component, allowing obtaining a geo-localization information which is automatically included in the reservation request. In a variant, when generating the reservation request, the user indicates the geographical area where he wishes to recover his vehicle. This area can for example be indicated from an interactive map displayed on a graphical interface of his equipment. The position of this geographical area is then attached to the reservation request and transmitted to the server SERV.

Within the scope of the present invention, the server SERV analyzes the reservation requests from the users U1-U4 and notes that the latter wish to recover their vehicle in the same geographical area, herein the train station GEO. In general, the server SERV can define that several users wish to recover their vehicle in the same geographical area when the positions indicated by each user are concentrated in a circle of predefined diameter, for example a circle whose diameter is comprised between 50 m and 1 km. In the example of FIG. 1, the geographical area GEO of the station can be defined by a circle whose center corresponds to the central point of said station and whose diameter is 400 m. The server SERV can thus calculate a first number of reservation requests in the geographical area GEO. Herein, the first number of requests is equal to 4, i.e. the number of users U1-U4.

The server SERV then queries the database to determine the fleet vehicles whose geographical position is included in the geographical area GEO and which are free (“Available” status). In the example of the FIG. 1, the server SERV calculates that only the vehicles CAR1 and CAR2 are available in the area GEO. The number of vehicles available in the geographical area GEO, referred to as the second number, is herein equal to 2.

The server SERV will compare the first number (demand) and the second number (offer). If the second number is greater than or equal to the first number (offer greater than or equal to the demand), then the server SERV will manage the reservations in a conventional manner and assign a vehicle to each of the users U1-U4.

If the second number is lower than the first number (offer lower than the demand), the server SERV will implement a logical computer process leading to the transmission, in a targeted manner, of the prompt requests. It is thus possible to encourage other users to release their vehicle in the geographical area GEO. This is the case in the example of FIG. 1, where there are only 2 available vehicles, CAR1 and CAR2, while 4 reservation requests have been received by the server SERV. The latter identifies vehicles which are unavailable and in use (“Unavailable-in operation” status), and whose geographical position is located in the geographical area GEO and/or at a predetermined distance from said geographical area.

The server SERV queries the database and selects the vehicles CAR5-CAR6 which are unavailable and in operation (“Unavailable-in operation” status). The vehicle CAR7 is not selected because its status is “Unavailable-Reserved”.

The server SERV selects from the selected vehicles CAR3-CAR6, those whose geographical position is located in the geographical area GEO or at a predetermined distance from said area. For example, the server SERV can identify the vehicles located within a 10 km radius of the geographical area GEO. More particularly in FIG. 1, the server SERV defines an enlarged area GEO′ included in a circle whose center corresponds to the central point of the station and whose diameter is 20 km. All vehicles included in this enlarged area GEO′, and only these, are retained by the server SERV. In FIG. 1, the vehicles CAR3-CAR5 are selected. The vehicle CAR6 being outside the enlarged area GEO′, it is not retained by the server SERV. For this vehicle CAR6, the process is masked, the user of said vehicle not being informed by the server SERV. Alternatively, the widened area GEO′ is defined not in terms of spatial distance, but in terms of temporal distance. For example, the server SERV retains the vehicles which are likely to take less than 10 minutes (or another determined time) to reach the geographical area GEO. Thanks to this selection, the server SERV only targets the users and vehicles that are most likely to be released in the geographical area GEO. The fact of targeting users and/or vehicles allows restricting the number of prompt requests to be transmitted, such that the processing time and the computer resources mobilized by the server SERV, as well as the bandwidth of the NET network, are reduced.

The server SERV generates a prompt request including the location (or geographical coordinates) of the geographical area GEO. One or more route(s) for conveying to the location of the geographical area GEO may be included in this request. In one example, the conveying routes take into account the road traffic so as to propose the fastest path to reach the geographical area GEO. These routes are calculated taking as a starting point the geographical position of the vehicles CAR3-CAR5. The routes can therefore be different from one vehicle to another.

The requests are called “prompt” in the sense that they encourage the users of the vehicles CAR3-CAR5 to release their vehicles in the geographical area GEO. To do this, the requests can include data allowing displaying a message of the type “by releasing your vehicle in the area GEO, you render service to other users of the community”. To further encourage the users, the requests advantageously include a billing discount datum, which is similar to an electronic discount coupon. In other words, and as explained further in the description, the prompt is financial: a discount is applied to the billed amount if the user actually releases his vehicle in the geographical area GEO. The need for vehicles in the geographical area GEO is generally limited in time, for example a Friday between 6 p.m. and 8 p.m. Outside this period, the reservation demand may not suffer from any peak. Also, it is advantageously provided that the discount coupon has a limited validity in time, for example Friday, 31 Dec. 2018, between 6 p.m. and 8 p.m. Beyond this time and date, no further billing discount will be granted.

The server SERV transmits these requests only to the selected vehicles CAR3-CAR5, through the NET network. These requests are in this case directly received by the on-board equipment CEQ3-CEQ5 of said vehicles. The reception of these requests by the equipment CEQ3-CEQ5 can trigger the display, on a graphical interface arranged in the vehicles CAR3-CAR5, of the location of the geographical area GEO (for example located on the map), possibly accompanied by one or more conveying route(s) and a prompt message of the type “by releasing your vehicle in the area GEO, you render service to other users of the community” or “by releasing your vehicle in the area GEO, you will benefit from a discount of X € on your bill”. This prompt message also mentions the duration of validity of the discount offer, for example “offer valid on Friday, 31 Dec. 2018, from 6 p.m. to 8 p.m.”. In a variant, the server SERV transmits the requests to the mobile equipment (eg: Smartphones) of the users of the vehicles CAR3-CAR5. This transmission is carried out through the NET network. Upon reception of these requests, the equipment can display on the graphical interface thereof, the location of the geographical area GEO, possibly accompanied by one or more conveying route(s) and a prompt message of the type “by releasing your vehicle in the area GEO, you render service to other users of the community” or “by releasing your vehicle in the area GEO, you will benefit from a discount of X € on your bill. Offer valid on Friday, 31 Dec. 2018, from 6 p.m. to 8 p.m.”. In another variant, the server SERV transmits the requests not only to the on-board equipment CEQ3-CEQ5 of the vehicles CAR3-CAR5, but also to the equipment of the users of said vehicles. Regardless of the embodiment, the users are automatically notified by the server SERV, and in a centralized manner.

Let's take the example where the user of the vehicle CAR3 responds favorably to the prompt request, in the sense that he releases his vehicle in the geographical area GEO. An indicator of availability of the vehicle CAR3 is then transmitted to the server SERV, allowing indicating to the latter that the vehicle CAR3 is available again. As previously explained, the availability indicator can be generated and transmitted from the on-board equipment CEQ3 of the vehicle CAR3 following the detection of an event. This event is for example generated by an action of the user on a specific command arranged on the dashboard of the vehicle CAR3 when he has parked and released said vehicle. The availability indicator can also be generated and transmitted from the mobile equipment (e.g., Smartphones) of the user of the vehicle CAR3, following an action of said user on his equipment. The user can for example actuate a dedicated key displayed on a touch screen of the equipment, after having parked and released his vehicle.

The server SERV determines the geographical position of the vehicle CAR3. As previously indicated, this geographical position can be obtained by satellite, by triangulation or by a combination of the two localization systems. The geographical position can still be generated by the user's mobile equipment and transmitted at the same time as the availability indicator. The server SERV also determines the amount to be billed following the use of the vehicle CAR3.

The server SERV compares the geographical position of the vehicle CAR3 and the position of the geographical area GEO. If the geographical position of the vehicle CAR3 corresponds to the location of the geographical area GEO, then the server SERV applies the billing discount to the amount to be billed. For example, if the initial amount to be billed is 20€ and the discount is 5€, then the server SERV will only bill 15€ to the user of the vehicle CAR3. Conversely, if the geographical position of the vehicle CAR3 does not correspond to the location of the geographical area GEO, then the server SERV will not apply the billing discount to the amount to be billed: 20€ will be billed to the user. As previously mentioned, the billing discount is only granted if the billing datum is still valid, that is to say that the user has indeed released his vehicle in the geographical area GEO during the period of validity of the discount offer (Friday, 31 Dec. 2018, from 6 p.m. to 8 p.m.).

Further, the discount is only granted to users who have voluntarily taken the step of meeting the needs of other users. It does not appear to justify granting a discount to users having released their vehicles in a hazardous manner in the geographical area GEO. Also, the discount is only granted if the prompt request has been transmitted to the vehicle CAR3 or to the mobile equipment of the user of said vehicle, prior to the generation of the availability indicator.

Several methods allow the server SERV to know whether the prompt request has been transmitted to a vehicle or to the mobile equipment of the user of said vehicle, prior to the generation of the availability indicator. According to one embodiment, the server SERV stores, in a memory area, the identifiers of the vehicles CAR3-CAR5 to which the prompt request has been transmitted. When the availability indicator is transmitted to the server SERV, the equipment CEQ3 of the vehicle CAR3 made available or the mobile equipment of the user of said vehicle, integrates or attaches to this indicator, the identifier of said vehicle. Upon reception of the availability indicator, it is sufficient for the server SERV to compare the identifier associated with the availability indicator with the identifiers stored in its memory area. If the identifier corresponds to a stored identifier, then the server SERV can determine whether the prompt request has been transmitted to the vehicle CAR3 or to the equipment of the user of said vehicle, prior to the generation of the availability indicator, said server then applying the discount. Otherwise, the server SERV does not apply the discount.

According to another embodiment, if the discount coupon is valid (i.e., it has not expired), it is associated with the availability indicator. This association is carried out by the equipment CEQ3 of the vehicle CAR3 made available, or by the mobile equipment of the user of said vehicle. In order to know whether it should apply the discount, the server SERV simply needs to check that the geographical position of the vehicle CAR3 corresponds to the location of the geographical area GEO. Indeed, insofar as the discount coupon is associated with the availability indicator, the server SERV automatically deduces therefrom that the prompt request has been transmitted to the vehicle CAR3, or to the mobile equipment of the user of said vehicle, prior to the generation of the availability indicator and that the discount coupon is valid. Compared to the previously described embodiment, this embodiment is particularly advantageous because the number of calculations performed by the server SERV is reduced, which allows consuming less energy and requiring less computer resources.

According to another embodiment, the discount coupon is systematically associated with the availability indicator, whether said coupon is valid or expired. In order to know whether it should apply the discount, the server SERV must therefore check, in addition to the geographical position of the vehicle CAR3, the validity of the discount coupon.

In the embodiments described in the preceding paragraphs, the server SERV calculates the first number of actual reservation requests, at a given moment, and defines its strategy depending on the vehicles actually available at a given moment. The aim of this strategy being to target the transmission of the prompt requests so that the offer of vehicles can compensate for the reservation demand, in a specific geographical area.

According to another embodiment, the server SERV is configured to anticipate a potential imbalance between the vehicle offers and the reservation demands, in a given geographical area. To do this, the server SERV calculates the first number of reservation requests by taking into account the number of estimated reservation requests, based on a history of the actual reservation requests over a time period prior to a given moment. By relying on a machine learning (which is a branch of the artificial intelligence), the server SERV can have the ability to anticipate potentially problematic situations, in the sense that, in given geographical areas, the vehicle offers may be lower than the reservation demands. By analyzing the evolution of the received reservation requests, the server SERV can anticipate that at a given period and in a particular geographical area, the demand to reserve vehicles is systematically very strong. For example, the server SERV can detect that every Friday of the year, between 6 p.m. and 8 p.m., at the exit of a specific train station, there are on average 15 reservation demands

Based on the example in FIG. 1, let's assume that two vehicles CAR1 and CAR2 are parked in the vicinity of the station GEO and are free (“Available” status). If at 6 p.m., only two users U1-U2 transmit a reservation request to the server SERV, the latter will note that the first number of actual reservation requests (=2) corresponds to the second number of available vehicles (=2). If the calculation of the first number is carried out by taking into account only the number of actual reservation requests at 6 p.m., then the server SERV will not implement the logical computer process allowing generating and transmitting the prompt requests. This can be problematic, because this logical process will only be implemented upon reception of a new reservation request (ex: at 6:10 pm). It takes some time before notified users release their vehicles in the vicinity of the station GEO (ex: not before 6:20 p.m.). The users having requested a reservation will therefore have to wait a certain lapse of time before recovering an available vehicle.

On the contrary, if the server SERV takes into account the history of the reservation requests, it will anticipate that about 15 reservation demands will be required from a given moment (ex: 6 p.m.). The first number calculated by the server SERV will therefore be equal to 15 and not to 2, this first number being greater than the second number of available vehicles (=2). From 6 p.m., and preferably before this time (ex: from 5:50 p.m.), the server SERV will be able to implement the logical process allowing generating and transmitting the prompt requests. The notified users will thus be able to reach the station GEO more quickly and release their vehicles in advance, such that the users having requested a reservation will wait less time.

According to another embodiment, the server SERV will calculate the first number of reservation requests by taking into account: the number of actual reservation requests at a given moment, and the number of estimated reservation requests, based on the history of the actual reservation requests during a previous period of time. For example, the server SERV begins by considering only an estimated number which is based on the history of the reservation requests (eg: 15 estimated requests). Then, as soon as the number of actual reservation requests exceeds this estimated number (ex: from 16 actual requests), the server SERV considers only this actual number. This technique allows optimizing the reduction in the waiting time for users having requested a reservation, at the beginning of the period of high demands, then managing in real time the rebalancing between the offer and the demand when the number of actual reservation demands exceeds the number of estimated demands.

The invention also concerns a computer program product including instructions for implementing the various steps of the method of the invention. The steps can be carried out by a computer program stored in the memory of the server SERV and whose instructions are executed by the processing unit of said server. According to different embodiments, steps of the method can be carried out by one or more equipment EQi, CEQj.

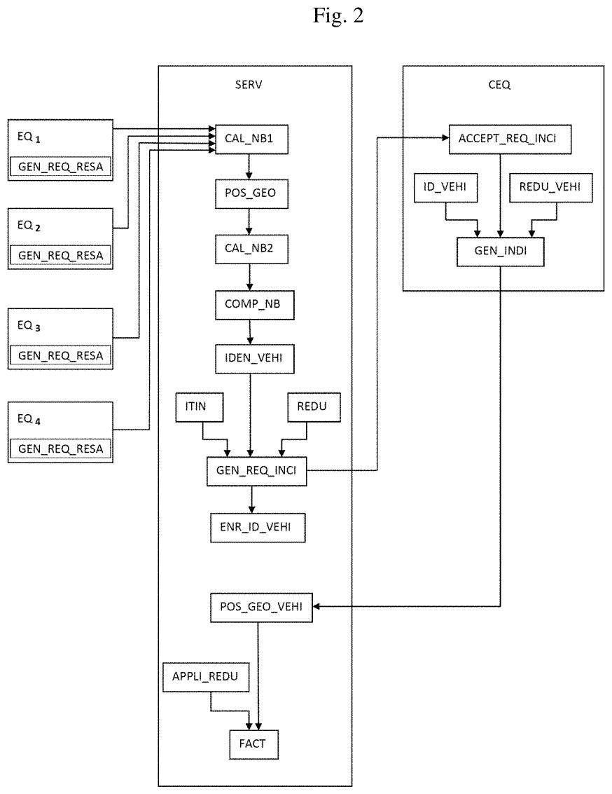

FIG. 2 shows a block diagram of the main steps of a method according to the invention. FIG. 2 schematizes five entities already represented in FIG. 1, namely the mobile equipment EQ1-EQ4 of the users U1-U4, the server SERV and the equipment CEQ of a vehicle CAR. According to a preferred embodiment:
The steps denoted GEN_REQ_RESA schematize the generation of the reservation requests from the mobile equipment EQ1-EQ4 of the users U1-U4.
These reservation requests are transmitted to the server SERV which then calculates the first number of reservation requests in the predetermined geographical area. This calculation step is denoted CAL_NB1.
In a step POS_GEO, the server SERV determines the geographical positions of the vehicles of the fleet and selects those which are localized in the concerned geographical area.
In step CAL_NB2, the server SERV calculates a second number, which corresponds to the number of vehicles localized in the concerned geographical area and having an “Available” status.

The order of the steps POS_GEO and CAL_NB2 can be reversed: the server SERV first searches for the vehicles having an “Available” status then selects from these vehicles those which are localized in the concerned geographical area.
In step COMP_NB, the server SERV compares the first number and the second number.
If the second number is lower than the first number, then, in a step IDEN_VEHI, the server SERV identifies the vehicles which have an “Unavailable-in operation” status, and whose geographical position is located in the concerned geographical area or at a predetermined distance therefrom.
In step GEN_REQ_INCI, the server SERV generates a prompt request including the location of the concerned geographical area. The billing discount coupon (step REDU) and/or one or more route(s) for conveying to the location of the concerned geographical area (step ITIN), can be associated with the prompt request. This request (and, if applicable, the discount coupon and/or the routes) is automatically transmitted to the vehicles identified in step IDEN_VEHI.
In a step ENR_ID_VEHI, the server SERV can store in a memory area, the identifiers of the vehicles identified in step IDEN_VEHI and to which the prompt request has been transmitted.
The step ACCEPT_REQ_INCI illustrates the reception of the prompt request by the equipment CEQ of a vehicle identified in step IDEN_VEHI.
In step GEN_INDI, the equipment CEQ of the vehicle generates an availability indicator, the user having released said vehicle in the concerned geographical area. A vehicle identifier can be associated with the availability indicator (step ID_VEHI). The discount coupon can also be associated with this indicator (step REDU_VEHI). This indicator (and, where appropriate, the vehicle identifier and/or the discount coupon) is transmitted to the server SERV.
In step POS_GEO_VEHI, the server SERV determines the geographical position of the vehicle having transmitted the availability indicator.
In step FACT, the server SERV determines the amount to be billed, with application of the discount (step APPLI_REDU) if the application conditions of the discount are met.

The steps ACCEPT_REQ_INCI, GEN_INDI, ID_VEHI, REDU_VEHI can be carried out by a mobile equipment of the users of the vehicles identified in step IDEN_VEHI.

The arrangement of the different elements and/or means and/or steps of the invention, in the embodiments described above, should not be understood as requiring such an arrangement in all implementations. In particular, one or more feature(s) exposed only in one embodiment can be combined with one or more other feature(s) exposed only in another embodiment. In particular, the discount coupon can be used later by a user, in order to obtain a billing discount on another trip. In addition to or as a substitute for the discount coupon, the server SERV can attach to the prompt request an electronic voucher offering users an additional service, for example the access at no additional cost, to a high-end vehicle model.

1-11. (canceled)

12. A method for transmitting a prompt request, comprising:
a) calculating, by a computer server, of a first number of requests to reserve vehicles in a fleet of shared vehicles, in a predetermined geographical area, the calculation of said first number is carried out taking into account:
the number of actual reservation requests received by the computer server at a given moment,
and/or a number of estimated reservation requests, which number is based on a history of the actual reservation requests received by the computer server, during a previous period of time,
b) determining by the computer server, of the geographical positions of the fleet vehicles and calculation of a second number of fleet vehicles which are available in the geographical area,
c) comparing, by the computer server, of the first number and the second number,
d) if the second number is lower than the first number, then identifying, by the computer server, of the fleet vehicles:—which are unavailable and in operation;—and whose geographical position is located in the geographical area or at a predetermined distance from said geographical area,
e) generating, by the computer server, of a prompt request including the location of the geographical area, and
f) automatically transmitting this prompt request, from the computer server via a wireless connection, to on-board equipment of the identified fleet vehicles or to at least one mobile equipment of the users of said identified vehicles.

13. The method according to claim 12, wherein as soon as the number of actual reservation requests received by the computer server at a given moment exceeds the number of estimated reservation requests, then said server considers only said number of actual reservation requests for the calculation of the first number.

14. The method according to claim 12, wherein the reception of the prompt requests by the on-board equipment of the vehicles, triggers the display, on a graphical interface arranged in said vehicles, of the location of the geographical area.

15. The method according to claim 12, wherein e) comprises a sub-step consisting in associating an electronic billing discount coupon with the prompt request, which coupon has a limited validity over time.

16. The method according to claim 15, further comprising:
g) generating and transmitting an availability indicator to the computer server, from a fleet vehicle which is made available or from a mobile equipment of the user of said vehicle, via a wireless connection,
h) determining, by the computer server, of the geographical position of said vehicle and of an amount to be billed following the use of said vehicle,
i) applying, by the computer server, of the billing discount to said amount to be billed under the following conditions:
the geographical position of the vehicle corresponds to the location of the geographical area, and
the prompt request generated in e) has been transmitted to the vehicle or to the mobile equipment of the user of said vehicle, prior to the generation of the availability indicator of g), and
the discount coupon is valid.

17. The method according to claim 12, wherein f) comprises a sub-step consisting in storing, in a memory area of the server, identifiers of the fleet vehicles to which the prompt request generated in e) has been transmitted.

18. The method according to claim 17, wherein:
g) comprises a sub-step consisting in associating an identifier of the vehicle with the availability indicator,
in i), the computer server compares the identifier associated with the availability indicator with the identifiers stored in the memory area thereof, to determine whether the prompt request generated in step e) has been transmitted to the vehicle or to the mobile equipment of the user of said vehicle, prior to the generation of the availability indicator of step g).

19. The method according to claim 15, further comprising:
g) generating and transmitting of an availability indicator to the computer server, from a fleet vehicle which is made available or from a mobile equipment of the user of said vehicle, via a wireless connection, the discount coupon being associated with said availability indicator if said coupon is valid,
h) determining, by the computer server, of the geographical position of said vehicle and of an amount to be billed following the use of said vehicle,
i) applying, by the computer server, of the billing discount to said amount to be billed, if the geographical position of said vehicle corresponds to the location of the geographical area.

20. The method according to claim 15, further comprising:
g) generating and transmitting of an availability indicator to the computer server, from a fleet vehicle which is made available or from a mobile equipment of the user of said vehicle, via a wireless connection, the discount coupon being associated with said availability indicator,
h) determining, by the computer server, of the geographical position of said vehicle and of an amount to be billed following the use of said vehicle,
i) applying, by the computer server, of the billing discount to said amount to be billed, if the geographical position of said vehicle corresponds to the location of the geographical area, and if the discount coupon is valid.

21. The method according to claim 12, wherein e) comprises a sub-step consisting in including, in the prompt request, one or more route(s) for conveying to the location of the geographical area.

22. A system for transmitting a prompt request, said system comprising a computer server adapted to communicate, via wireless connections, with the fleet vehicles, which server includes at least one processing unit, and at least one memory comprising one or more computer application(s) whose instructions, when executed by said processing unit, allow said server:
a) to calculate a first number of requests to reserve vehicles in a fleet of shared vehicles, in a predetermined geographical area, the calculation of said first number is carried out taking into account:
the number of actual reservation requests received by the computer server at a given moment,
and/or a number of estimated reservation requests, which number is based on a history of the actual reservation requests received by the computer server, during a previous period of time,
b) to determine the geographical positions of the fleet vehicles and calculate a second number of available fleet vehicles in the geographical area,
c) to compare the first number and the second number,
d) if the second number is lower than the first number, then to identify fleet vehicles:—which are unavailable and in operation;—and whose geographical position is located in the geographical area or at a predetermined distance from said geographical area,
e) to generate a prompt request including the location of the geographical area,
f) to automatically transmit this prompt request, via a wireless connection, to the identified fleet vehicles or to at least one mobile equipment of the users of said identified vehicles.
